(19) United States
(12) Patent Application Publication
(10) Pub. No.: US 2004/0147631 A1
(43) Pub. Date: Jul. 29, 2004

(54) Ink for an ink jet

(76) Inventor: Gunter Helling, Odenthal (DE)

Correspondence Address: Connolly Bove Lodge & Hutz, P O Box 2207, Wilmington, DE, 19899-2207, US

(21) Appl. No.: 10/471,199

(22) PCT Filed: Mar. 1, 2002
(86) PCT No.: PCT/EP02/02292

(30) Foreign Application Priority Data
Mar. 12, 2001 (DE) 101 11 655.1

(51) Int. Cl. C03C 17/00; C09D 5/00

(52) U.S. Cl. 523/160; 523/161

(57) ABSTRACT

The invention relates to ink for an ink jet, said ink containing a dye which is linked to a polymer skeleton. The inventive ink is characterised in that the dye is an azomethine dye, an indoaniline dye or an azo dye; and the polymer is a copolymer consisting of at least one hydrophobic monomer and at least one hydrophilic non-ionic monomer, the molecular weight of the hydrophilic, non-ionic monomer being at least 200. Even after a long storage time, the inventive ink does not cause nozzles to be clogged and creates a printed image which is highly resistant to wiping and water and has good gloss.

The present invention relates to ink for the production of ink jet images which are sprayed onto a suitable recording material in a fine image-wise modulated stream. The recording material is composed of a transparent, semi-transparent or opaque support and an image-receiving layer coated thereon.

The ink jet method is known (see for example the chapter “Ink Jet Printing” from R. W. Kenyon in “Chemistry and Technology of Printing and Imaging Systems”, editor Peter Gregory, Blackie Academic & Professional, Chapman & Hall 1996, pages 113 to 138, and the literature cited therein).

Polymeric dyes obtained by conversion of reactive dyes with polyamidoamines are known from EP 657 509 for use in inks for ink jet printing systems. However, such inks suffer from unsatisfactory storage stability.

A problem related to ink jet images is their stability and rub-resistance.

It is known from EP 672 538 to add reactive components to the coating masses of the base in order to obtain ink jet printing which is water-fast and rub-resistant. These additives cause cross-linking of the coating mass upon subsequent irradiation of the image, resulting in an improved rub-resistance of the dye previously incorporated into these vehicles.

This method has the drawback of requiring a further expensive process step after the printing operation, such as irradiation with UV light. In addition, further additives, e.g. photo-initiators, have to be added which tend to yellow upon storage und give the image whites an unattractive look. Further on, short UV irradiation times do not allow for the desired improvement of the fading of the prints.

DE 19 651 689 discloses the use of polymeric azomethine dyes or indoaniline dyes in dissolved or dispersed form. While these dyes provide a satisfactory dye stability and rub-resistance, the storage stability of the dyes dispersed in the inks remains unsatisfactory. Prior art inks in particular often cause clogging of the nozzles of the printing head.

It is the object of the present invention to provide a storage-stable ink for an ink jet printing process with which printed images can also be produced on different bases without special preparation, said images exhibiting high gloss and good waterfastness and rub-resistance and said ink not causing nozzles to be clogged, even after a long storage time.

It has now been found that inks containing a polymeric azomethine dye, indoaniline dye or azo dye consisting of hydrophobic and hydrophilic segments satisfy the above requirements.

According to the present invention there is provided an ink for an ink jet, said ink containing a dye linked to a polymer skeleton, characterized in that the dye is an azomethine dye, an indoaniline dye or an azo dye and the polymer is a copolymer consisting of at least one hydrophobic monomer and at least one hydrophilic, non-ionic monomer, the molecular weight of the hydrophilic, non-ionic monomers being at least 200.

A monomer with a covalently bound dye radical is also referred to hereinafter as dye monomer and a polymer with a covalently bound dye as dye polymer or polymeric dye.

The ink for an ink jet contains in particular 1 to 30% by weight of polymeric dye, preferably 2 to 10% by weight.

Suitable polymeric azo dyes for the inks of the present invention are described e.g. in Polymer News, 1990, vol. 15, p. 301-306, and in the literature references cited therein.

Polymeric azomethine dyes or indoaniline dyes are known from photographic materials and are obtained e.g. by reacting polymeric color couplers with color developers and oxidants. Polymeric color couplers are described in DE 1 297 417, 2 407 569, 3 148 125, 3 217 200, 3 320 079, 3 324 932, 3 331 743, 3 340 376, EP 27 284, U.S. Pat. Nos. 4,080,211 and 5,234,807. Monomeric color couplers that can be converted into polymeric color couplers through copolymerization are known from U.S. Pat. No. 5,234,807.

Suitable color developers, usually p-phenylenediamine compounds having a primary amino group, are described e.g. in “The Theory of the Photographic Process”, T. H. James, 4^{th} Edition, Macmillan Publishing Co., Inc. New York, p. 291 a.f., and in DE 195 03 885.

The polymeric azomethine dyes or indoaniline dyes are obtained e.g. by a polymer analogue reaction in which a polymeric color coupler containing a developer is converted into a polymeric azomethine dye or a indoaniline dye in the presence of an oxidant.

Another possibility consists of producing firstly a low-molecular weight polymerizable or polycondensable dye and then converting this dye into a high molecular dye through a consecutive reaction.

The azomethine dyes or indoaniline dyes preferably contain a p-phenylenediamine derivative as coupling component. Particularly preferred are compounds according to the formula:

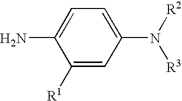

| R¹ | R² | R³ |
|---|---|---|
| H | C₂H₅ | C₂H₅ |
| H | C₂H₅ | C₂H₄OH |
| CH₃ | C₂H₅ | C₂H₅ |
| CH₃ | C₂H₅ | C₂H—NH—SO₂CH₃ |
| CH₃ | C₂H₅ | C₂H₄OH |
| CH₃ | C₂H₅ | C₂H₄OCH₃ |
| H | C₄H₉ | C₄H₈—SO₃H |

Polymeric dyes with hydrophobic and hydrophilic segments can be obtained by copolymerization of monomeric dyes with hydrophobic comonomers and hydrophilic macromonomers (MA). By hydrophilic macro-monomers is to be understood hydrophilic oligomers or polymers containing at least one polymerizable group.

Another possibility of producing polymeric dyes with hydrophobic and hydrophilic segments is the polymer analogue reaction in which a polymer with reactive groups is converted by means of a dye and hydrophobic and hydrophilic compounds and then transferred into dispersion.

Preferably, the dye is covalently bound to at least one hydrophobic monomer. The dyes are preferably linked to the polymer chain by a —C(═O)—O—, —(C═O)—NH—, —S(═O)₂—NH— or phenylene group.

In addition to the hydrophobic and the hydrophilic monomer it is preferred to use an additional comonomer. Particularly suitable for this purpose are ethylenically unsaturated compounds, in particular acrylates, methacrylates, optionally substituted acrylamides, optionally substituted methacrylamides, maleic acid derivatives, optionally substituted styrenes, α-methyl styrene, vinyl ether, vinylsulfonic acid, (meth)acrylic acid, vinyl pyrrolidine or vinyl pyridine.

The proportion of dye monomer in the dye polymer preferably lies between 10 and 80% by weight, more preferably between 20 and 50% by weight and the proportion of hydrophilic macromonomers and/or hydrophilic segments in the dye polymer preferably ranges from 1 to 60% by weight, more preferably from 2 to 30% by weight.

In a preferred embodiment the hydrophilic, non-ionic monomer is a macromonomer (MA):

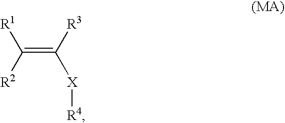

wherein:

R¹, R², R³ represent substituents, in particular each independently hydrogen, halogen, a C1-C4 alkyl group, —C(═O)—O—R⁵ or —O(═O)—NH—R⁵,

X represents a chemical bond or a linking group,

R⁴ represents an oligomer or polymer radical having a molecular weight ranging from 200 to 20000 and

R⁵ represents hydrogen, alkyl, aryl or aralkyl and

R⁴—H exhibits a water solubility of at least 10 g/l at a temperature of 25° C.

It is particularly advantageous if in the macromonomer (MA)

R³ represents —C(═O)—O—R⁵, Cl or F,

X represents a chemical bond, —C(═O)—, —C(═O)—O—, —C(═O)—NH—, —S(═O)₂—, —S(═O)₂—NH—, —NH—C(═O)—O—, —NH—C(═O)—NH—, —O—CO—NH—, alkylene, phenylene, aralkylene, -phenylene-C(═O)—O— or -phenylene-S(═O)₂—NH— and

R⁴ represents an oligomer or polymer radical having a molecular weight of at least 250 to 10000 and

R⁴—H exhibits a water solubility of at least 25 g/l at a temperature of 25° C.

In a particularly advantageous embodiment R⁴ contains one of the following structural elements:

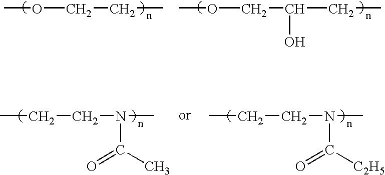

wherein n is at least 5, in particular at least 10.

Examples of hydrophilic macromonomers are:

| | | |
|---|---|---|
| MA-1 | 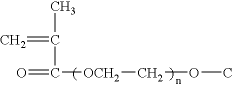 | Mₙ = 1000 |
| MA-2 | 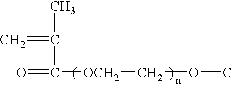 | Mₙ = 4000 |
| MA-3 | 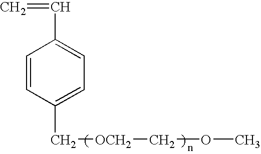 | Mₙ = 1000 |
| MA-4 | 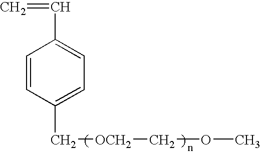 | Mₙ = 5000 |
| MA-5 | 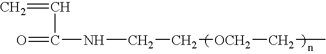 | Mₙ = 3000 |
| MA-6 | 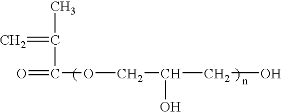 | Mₙ = 4000 |
| MA-7 | 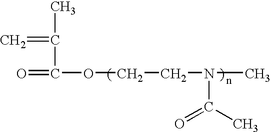 | Mₙ = 2000 |
| MA-8 | 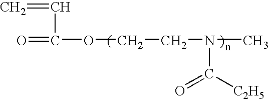 | Mₙ = 1000 |
| MA-9 | 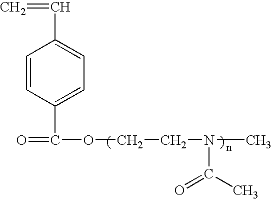 | Mₙ = 4000 |
| MA-10 | 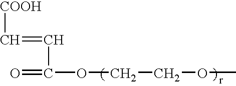 | Mn = 1200 |

Macromonomers are known from Chen. et al. J. Polym. Sci. Part A 38, 1811-1817 (2000), Miyamoto et al., Macromolecules 22 (4), 1604-1607 (1989), and Kobayashi et al., Polymer Bulletin 13, 447-451 (1985).

Examples of dye polymers with hydrophobic and hydrophilic segments according to the present invention are listed hereinafter.

The formulae indicate in which degree of percentage by weight the single monomers were mutually polymerized.

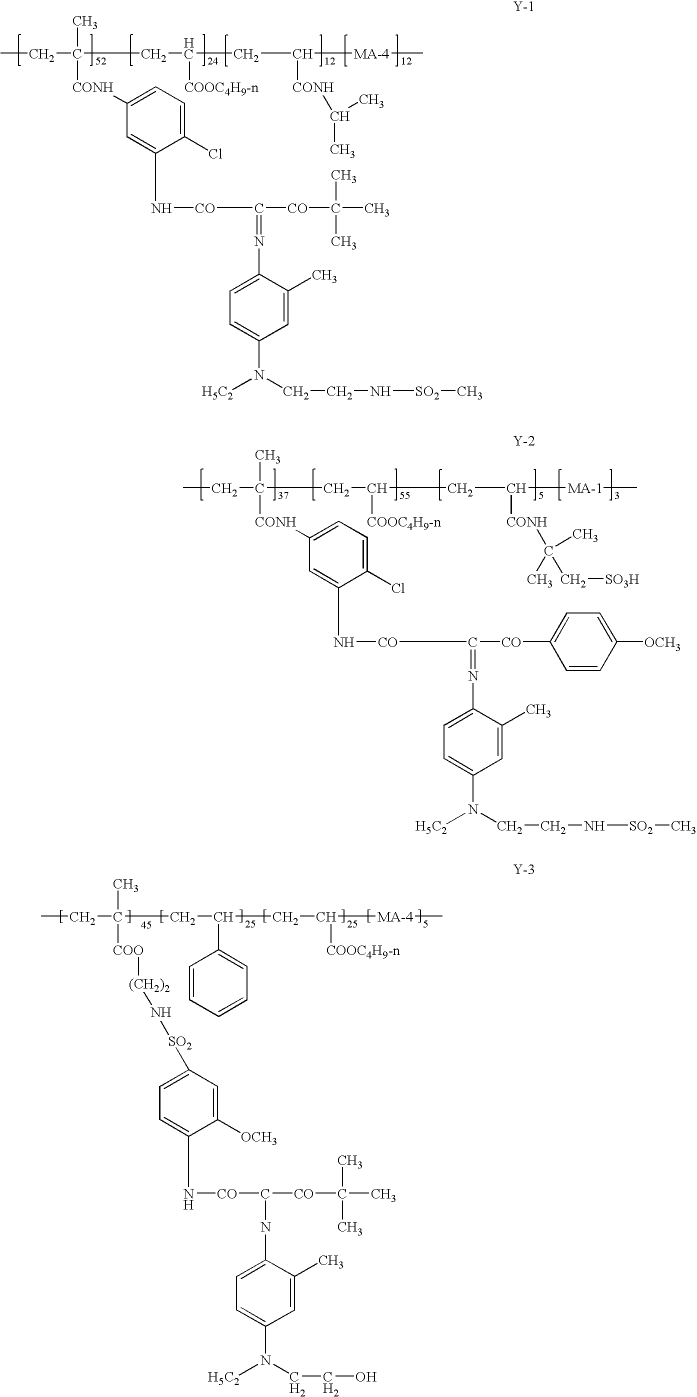

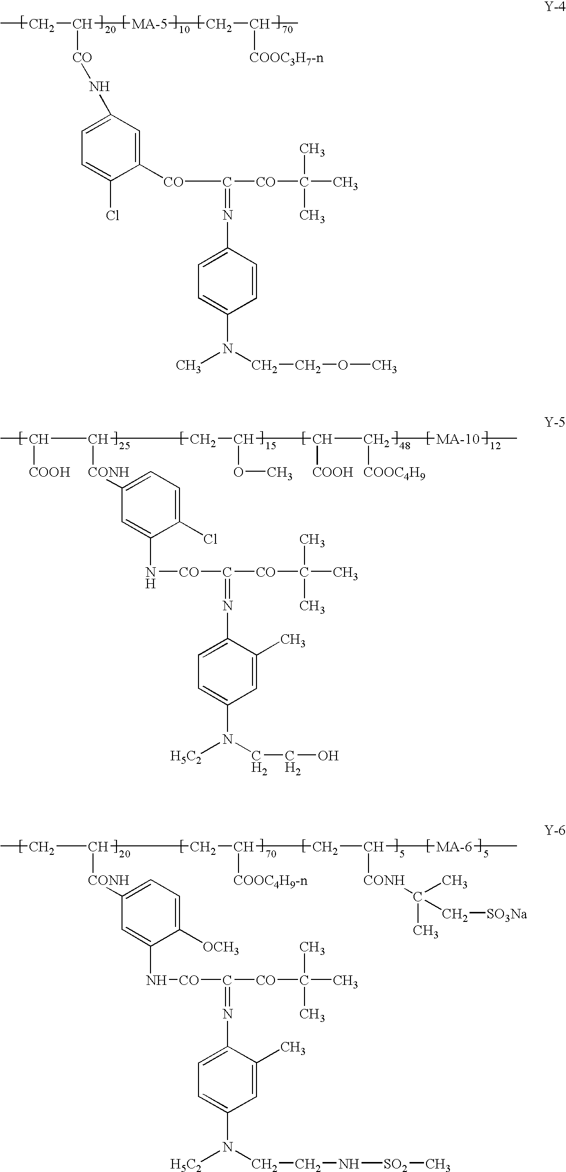

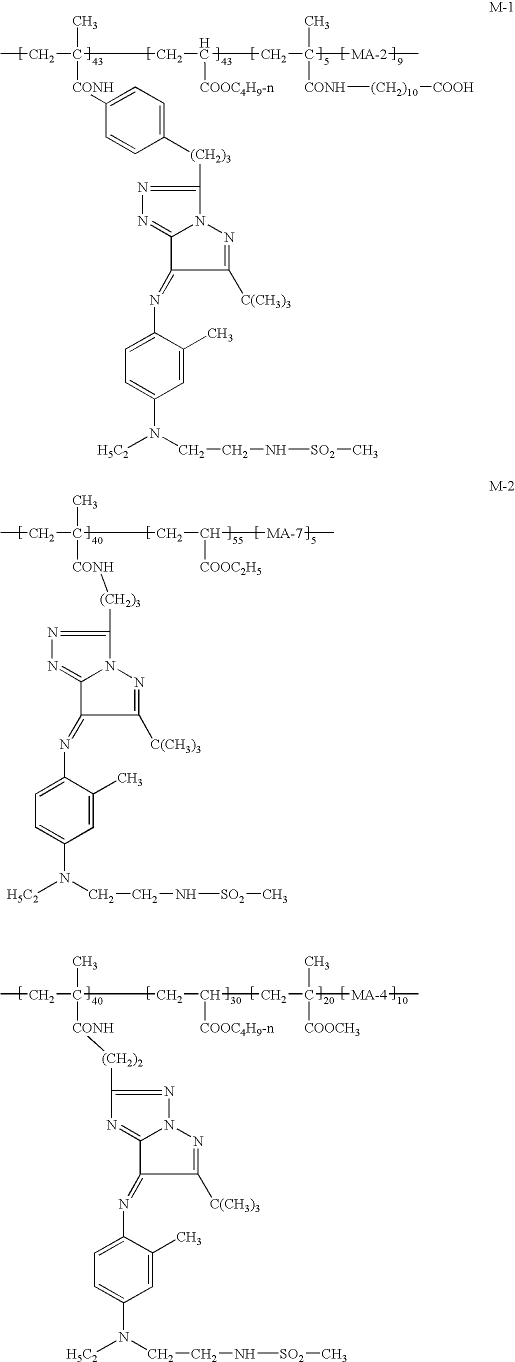

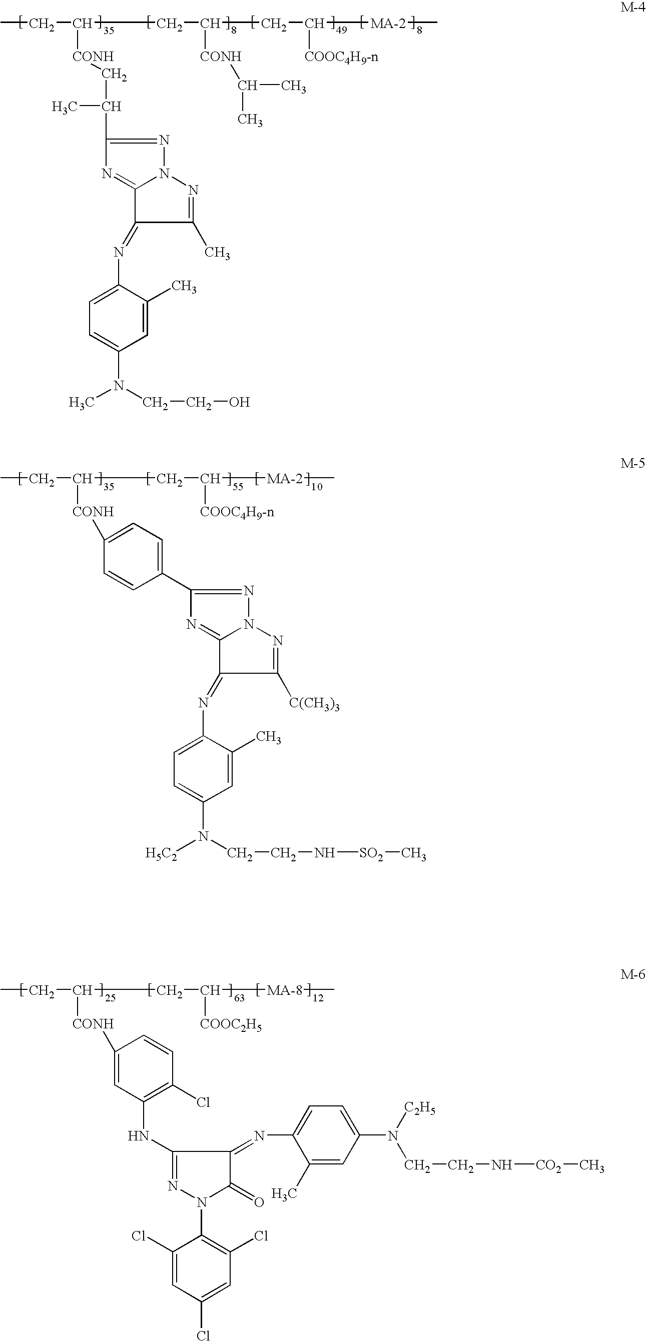

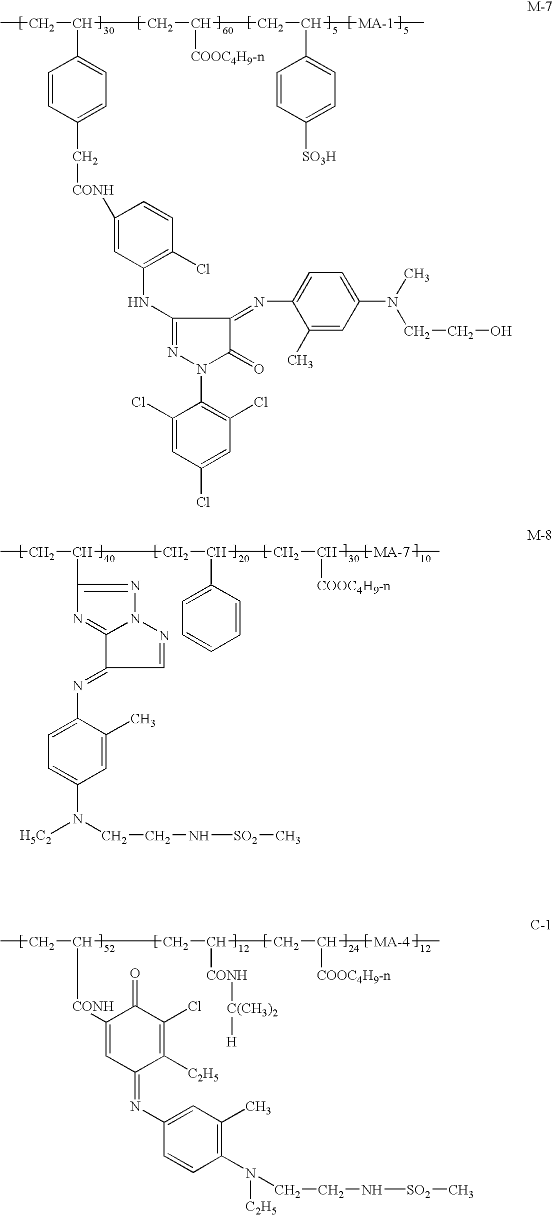

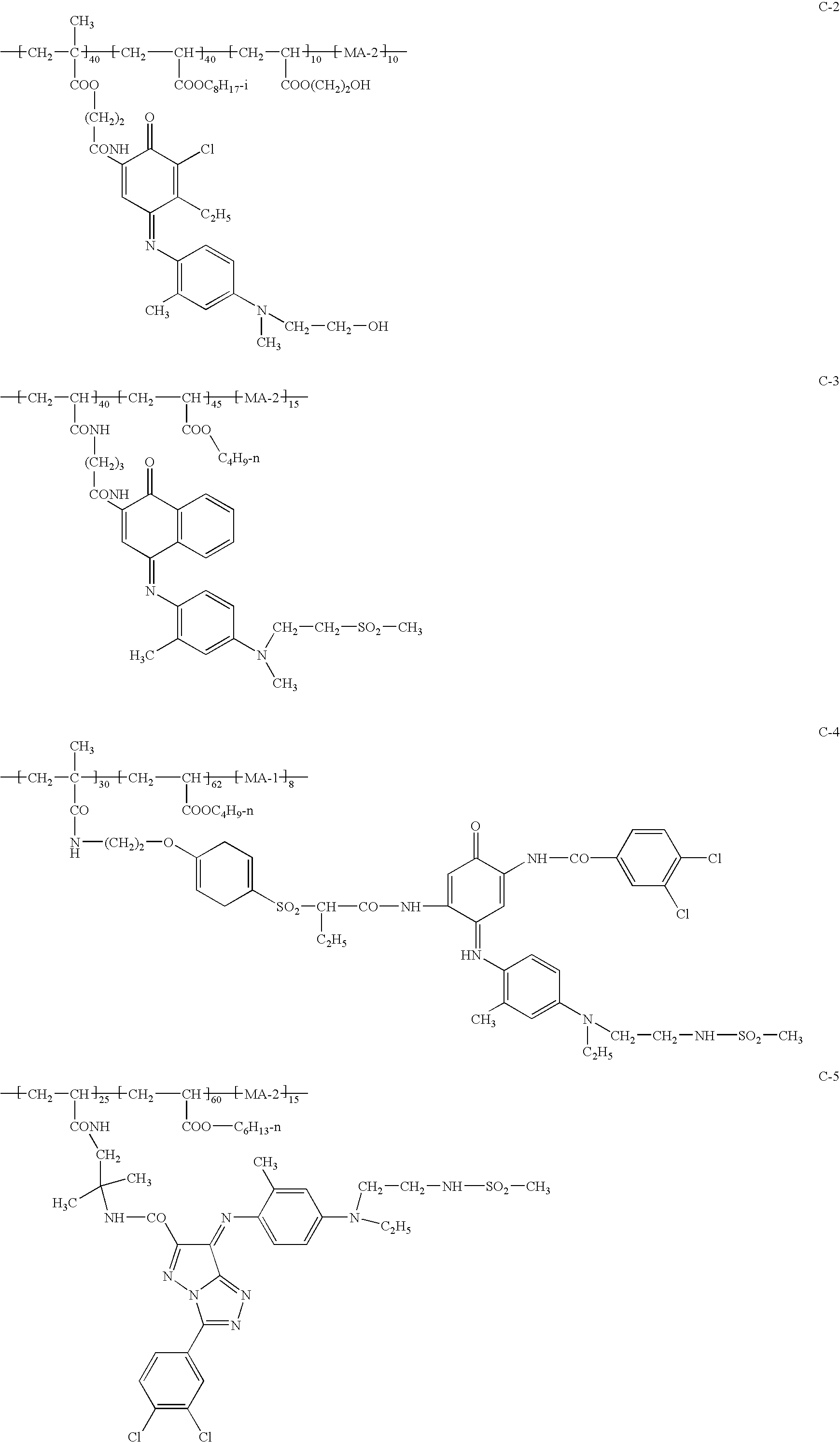

The ink may contain further additives such as biocides, wetting agents and surface-active agents, spacers, matting agents, stabilizers, UV-absorbers, solvents, plasticizers and lubricants.

Suitable biocides, e.g. isothiazolones and benzoisothiazolones, are described in Wallhäuβer, “Praxis der Sterilisation, Desinfektion, Konservierung”, Thieme Verlag Stuttgart, 1988.

Suitable wetting agents or surface-active compounds are natural surface-active compounds such as saponine or synthetic surface-active compounds such as non-ionic surfactants, e.g. alkylene oxide compounds, glycerine compounds or glycidol compounds, cationic surfactants, e.g. higher alkylamines, quaternary ammonium salts, pyridine compounds and other heterocyclic compounds, sulfonium compounds or phosphonium compounds, anionic surfactants containing an acid group, e.g. a carboxy, sulfo, phospho, sulfuric or phosphoric ester group, ampholytic surfactants, e.g. aminoacid and aminosulfonic acid compounds and sulfuric or phosphoric esters of an aminoalcohol.

Further surface-active compounds are described in RD 308 119 (1989). and in EP 314 425, 362 990, 549 496, U.S. Pat. Nos. 4,839,262, 4,847,186, 4,916,054, 5,221,603, WO 90/12 782 and WO 92/15 554.

Suitable stabilizers are o-, m- and p-dihydroxybenzenes, hydroxychromans, 5-hydroxycoumarins, spirochromans, spiroindans, p-alkoxyphenols, sterically hindered phenols, gallic acid derivatives, methylene dioxybenzenes, aminophenols, aminoanilines, sterically hindered amines, derivatives with esterified or etherified phenolic hydroxyl groups, derivatives with acylated or alkylated aromatic amino groups and metal complexes. Detailed descriptions can be found in RD 307 105 (1989) chapter VII, EP 246 766, 273 712, 304 067, 471 341, 524 540, 544 316, 544 317, 545 305, 585 679, 586 343, DE 42 09 346, 43 20 444, 43 23 477 and in U.S. Pat. Nos.5,294,530 and 5,278,039.

In many cases the use of particular combinations of color image stabilizers has proven to be particularly effective. Such combinations are described e.g. in U.S. Pat. Nos. 5,104,782 and 5,139,931, EP 298 321, 355 660, 457 543, 477 870, JP 0305 1846 and in DE 42 29 132, 43 14 690 and 43 26 647.

Suitable UV-absorbers are described in DE 195 03 885.

Plasticizers and lubricants are described in RD 307 105 (1989), chapters XII A and B. Core-shell latices having a soft core and a rigid shell and latices composed of a soft core and a shell made of cross-linked gelatin (U.S. Pat. No. 5,066,572) are also used.

Suitable solvents for use as ink additive are e.g. alcohols such as ethanol, glycol, glycerine, butanediol, pentanediol, hexanetriol, diethylene glycol, polyethylene glycol, isopropanol, triethylene glycol monobutyl ether, thiodiethylene glycol, thiodiglycol, amides such as pyrrolidone, methyl pyrrolidone, dimethyl acetamide and ureas such as tetrabutyl urea.

The polymeric azomethine dyes can be water-soluble or water-insoluble. The water-soluble dyes are directly used as aqueous ink ingredients. The water-insoluble polymeric azomethine dyes are used in dispersed or emulsified form as latex. The water-insoluble dyes can also be obtained directly as dispersion by preparing polymer latex color couplers and converting the latices into latex dyes by reacting them with developers.

According to the invention use is preferably made of dispersed or latex dyes.

The average particle sizes of the dispersed or latex dyes range from 10 to 2000 nm, preferably from 30 to 300 nm.

The dispersed or latex particles may be composed of linear or cross-linked macromolecules.

In a preferred embodiment the ink contains a further polymer dispersion or polymer latex as vehicle, in addition to the polymeric azomethine dye or azo dye.

Suitable polymer latices are e.g. polyacrylates, polymethacrylates, polyalkylenes such as polyethylene, polybutylene, polyvinylidene chlorides, polyurethanes, polyesters, polyamides and polyureas.

Preferred are polymer latices having a glass transition temperature of less than 50° C. The polymer dispersions exhibit an average particle size of 10 to 3000 nm, preferably 20 to 400 nm.

The amount of polymer latices added preferably ranges from 10 to 500% by weight, based on the polymeric dye used.

Particularly good results can be obtained with aqueous ink jet inks, in particular if the dye polymer is used as a dispersion of particles showing an average diameter between 30 and 300 nm. In this regard it is particularly advantageous if the polymer particles are structured and are composed of a hydrophobic inner region containing the dye and a hydrophilic shell.

The preparation of the dye polymers of the present invention proceeds according to a method comprising the steps of polymerizing at least one azomethine dye, indoaniline dye or azo dye monomer and at least one macromonomer (MA) in solution in the presence of at least one organic solvent, then adding at least 25% by weight of water to the reaction mixture and then distilling off at least an equivalent amount of the organic solvent until a polymer dispersion composed of particles having an average diameter of not more than 300 nm, preferably 30 to 300 nm and more preferably 30 to 100 nm, is formed, whereby the organic solvent and the amount of water must be chosen so that the solution is still homogeneous directly after the addition of the water and subsequently a higher amount by weight of organic solvent than water is distilled off.

Further preferred embodiments of the present invention are disclosed in the dependent claims.

Preparation of the Magenta Dye M-1 of the Present Invention

0.7 g of oleyl methyl tauride was dissolved in 136 ml of water under nitrogen and heated to 80° C. Then 0.57 g of an initiator solution of 2 g of potassium persulfate in 100 ml of water and a suspension of 4.5 g of coupler K-I, 7.5 g of butyl acrylate, 1.9 g of methacrylamido-undecanoic acid and 1.1 g of MA-2 in 68 ml methanol were added simultaneously to this solution. Then additional 6.8 ml of initiator solution were added dropwise within 1 hour before stirring the whole for further 2 hours at 80° C. Subsequently, the methanol was distilled off and the aqueous residue adjusted to a solids content of 10% by weight. A finely divided latex coupler was obtained.

The latex coupler was mixed with 1.5 g of the wetting agent N-1. Subsequently, 3.5 g of CD 3 and 4.6 g of potassium persulfate were added, followed by stirring for 30 minutes at 40° C. after adjusting the pH to 10.5. The resulting magenta dye latex was dialyzed for 36 hours and concentrated to 10% by weight. The latex has an average particle size of 83 nm.

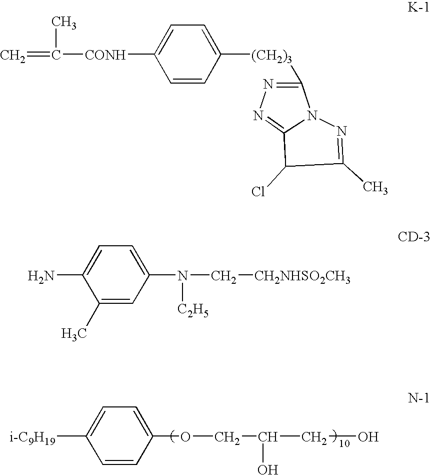

Preparation of the Cyan Dye C-1 of the Present Invention

0.8 g of oleyl methyl tauride in 80 ml of water was heated to 95° C. under nitrogen. Then a solution of 0.12 g of azo-bis-cyanovaleric acid sodium salt dissolved in 3 ml of water, 2.6 g butyl acrylate and 3.7 g of a suspension of 8.4 g of the phenolic coupler monomer 2-chloro-3-ethyl-4-chloro-6-acrylamidophenol, 4.15 g of i-propylacrylamide, 4.15 g of MA-4 and 0.4 g of oleyl methyl tauride in 20 g of water were added thereto. Thereafter, a metered addition of the residual amounts of the above-mentioned suspension and 5.7 g of acrylic butyl ester was carried out over 1 hour. After 2 hours of stirring at 95° C., the unconverted acrylic butyl ester was removed by water vapor distillation. A finely divided latex having a solids content of 18.3% by weight was obtained.

The latex coupler was mixed with 2.5 g of the wetting agent N-1. Subsequently, 9.9 g of CD 3 and 20 g of potassium persulfate was added, followed by stirring for 30 minutes at 45° C. after adjusting the pH to 10.8. The resulting cyan dye latex was dialyzed for 36 hours and concentrated to 15% by weight. The latex has an average particle size of 94 nm.

Preparation of the Yellow Dye Y-1 of the Present Invention

The preparation proceeds as described for C-1, with the exception that the phenolic coupler monomer was replaced by the monomer K-2 in equivalent amounts.

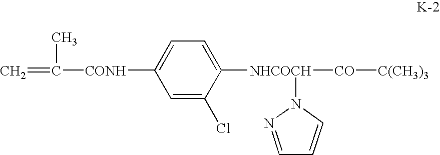

A 19.5% by weight latex having an average particle size of 78 nm was obtained.

Preparation of the Yellow Dye Y-2 of the Present Invention

3 solutions were prepared: solution A contains 20 g of 50% by weight sodium acrylamido-2-methylpropane sulfonate in water, 110 g of butyl acrylate, 74 g of dye K-3 and 6 g of monomer MA-1 in 212 g of n-propanol and 18 g of water. Solution B contains 2.1 g of azo-bis-isobutyronitrile, 127 g of n-propanol and 4 g of water. Solution C contains 0.7 g of azo-bis-isobutyronitrile, 44 g of n-propanol and 2 g of water.

86 g of solution A and 25 g of solution B were heated to 90° C. Then a metered addition of residual solution A and B at reflux temperature was carried out within 2 hours, followed by a further 4 is hours of stirring at reflux temperature. Thereafter, solution C was added and stirring was continued for 4 hours at reflux temperature. Subsequently, 1250 g of water was metered into the mixture and 800 ml of propanol and water were removed by distillation.

A finely dispersed dye dispersion with an average particle size of 43 nm which was adjusted to 10% by weight with water, was obtained.

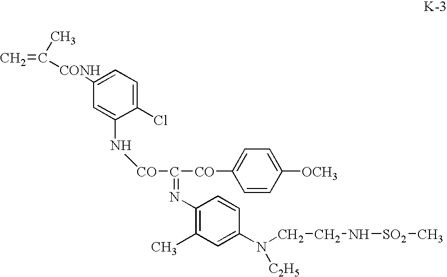

### EXAMPLE 1

A base for reflection printing was prepared by coating 90 g/m² paper, which was coated with polyethylene on both sides, with a 5 gelatin layer having a thickness of 10 μm. 0.1% by weight (based on the gelatin) of C₈F₁₇SO₃^{Θ}C₂H₅)₄N⁶¹ was used as wetting agent for the coating.

Ink 1 was prepared by the addition of 0.8 g of diethylene glycol to 10 ml of the 10% by weight dispersion of M-1.

Ink 2 was prepared by the addition of 0.5 g of pyrrolidone and 0.5 g of diethylene glycol to 10 ml of the dispersion of C-1 that was diluted to 10% by weight with distilled water.

Ink 3 was prepared by the addition of 1.0 g of diethylene glycol to 10 ml of the 10% by weight dispersion of Y-2.

Inks 4 to 8 were prepared by the addition of further polymers to the inks 1 to 3 (see table 1).

TABLE 1

| Ink | Original ink/amount | Polymer added/Amount |
|---|---|---|
| 4 | 1/10 g | Polymer 1/6 g |
| 5 | 1/10 g | Polymer 2/4 g |
| 6 | 2/10 g | Polymer 1/7 g |
| 7 | 2/10 g | Polymer 2/10 g |
| 8 | 3/10 g | Polymer 3/8 g |

Polymer 1

10% by weight latex of polyethyl acrylate having a particle size of 60 nm.

Polymer 2

10% by weight latex of a polyester polyurethane latex obtained from an adipic acid/butanediol polyester diol, hexamethylene diisocyanate and N-sulfoethyl ethylenediamine having a particle size of 50 nm.

Polymer 3

10% by weight latex obtained from polymethyl methacrylate-co-butyl acrylate-co-2-acrylamido-2-methyl-propane-sulfonic acid (30/65/6% by weight) having a particle size of 85 nm.

### APPLICATION EXAMPLE 1

The base described in example 1 was printed with 1 cm wide cyan, yellow and magenta strips in a HP DJ 850 printer and the resulting colored layers D₁ were measured on a Macbeth densitometer. Subsequently, the printed base was pressed against a commercial Agfa 2001 copying paper by means of a pair of squeegee rollers. Part of the dyes was thereby transferred onto the copying paper. This process was followed by measuring again the densities D₂ on the paper base. The relative decrease of he density ΔDᵣₑₗ is a measure for the fastness of the dyes on the base:

$$Δ {D}_{rel } = \frac{{D}_{1} - {D}_{2}}{{D}_{1}} \cdot 100$$

The measured values are listed in table 2 and show that the inks of the present invention have a clearly better pick-up (transfer) resistance than common inks.

The following commercial ink dyes were used:

| | |
|---|---|
| Yellow: Colour Index AY 23 | (a) |
| Magenta: Colour Index AR 52, RR 180 | (b) |
| Cyan: AB 9, DB 199 | (c) |

TABLE 2

| Ink | Color | D₁ | D₂ | ΔDᵣₑₗ | |
|---|---|---|---|---|---|
| A | yellow | 1.40 | 1.27 | 9.3 | comparative |
| b | magenta | 1.95 | 1.70 | 12.8 | comparative |
| c | cyan | 2.75 | 2.51 | 8.7 | comparative |
| Ink 1 | magenta | 1.85 | 1.82 | 1.6 | invention |
| Ink 2 | cyan | 2.43 | 2.41 | 0.8 | invention |
| Ink 3 | yellow | 2.28 | 2.25 | 1.3 | invention |
| Ink 4 | magenta | 2.04 | 2.04 | 0 | invention |
| Ink 5 | magenta | 2.13 | 2.09 | 1.9 | invention |
| Ink 6 | cyan | 2.50 | 2.48 | 0.8 | invention |
| Ink 7 | cyan | 2.24 | 2.21 | 1.3 | invention |
| Ink 8 | yellow | 1.94 | 1.93 | 0.5 | invention |

### APPLICATION EXAMPLE 2

The ink-printed strips described in application example 1 were washed at room temperature for 30 seconds. As for the comparative samples, clearly disturbing 1 mm wide fringing was thereby formed for all colors. The examined samples of the samples of the present invention showed no changes.

### APPLICATION EXAMPLE 3

100 ml of the inks 1 to 3 of the present invention and the comparative inks were filtered through a filter having a pore width of 0.8 μm and stored at room temperature for 60 days. Subsequently, a filtration was carried out through a filter having a pore width of 1.2 μm and the filtration residue was determined.

| | Filtration residue |
|---|---|
| Ink 1 | no residue |
| Ink 2 | no residue |
| Ink 3 | no residue |
| V-1 | 0.3 mg of residue |
| V-2 | 1.7 mg of residue |
| V-3 | 98 mg of residue |

From the measured data it can be seen that the inks of the present invention are stable on storage, whereas the comparative inks result in agglomeration during storage and cause nozzles to be clogged in practice.

The preparation of the comparative inks was carried out as described in DE 19 651 689:

V-1=ink 1 of DE 19 651 689

V-2=ink 2 of DE 19 651 689

V-3=ink 3 of DE 19 651 689

1. An ink for an ink jet, said ink containing a dye linked to a polymer skeleton, wherein the dye is an azomethine dye, an indoaniline dye or an azo dye and the polymer is a copolymer consisting of at least one hydrophobic monomer and at least one hydrophilic, non-ionic monomer, the molecular weight of the hydrophilic, non-ionic monomers being at least 200 and said dye being bound to at least one hydrophobic monomer.

2. An ink for an ink jet according to claim 1, wherein the polymer is composed of at least one further monomer.

3. An ink for an ink jet according to claim 1, wherein at least one non-ionic monomer is a macromonomer (MA): 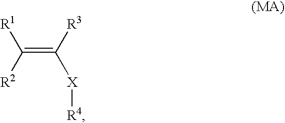
wherein
R¹, R², R³ represent substituents, in particular each independently representing hydrogen, halogen, a C1-C4 alkyl group, —C(═O)—O—R⁵ or —C(═O)—NH—R⁵,
X represents a chemical bond or a linking group,
R⁴ represents an oligomer or polymer radical having a molecular weight ranging from 200 to 20000 and
R⁵ represents hydrogen, alkyl, aryl or aralkyl and
R⁴—H exhibits a water solubility of at least 10 g/l at a temperature of 25° C.

4. An ink for an ink jet according to claim 3, wherein
R³ represents —C(═O)—O—R⁵, Cl or F,
X represents a chemical bond, —C(═O)—, —C(═O)—O—, —C(═O)—NH—, —S(═O)₂—, —S(═O)₂—NH—, —NH—C(═O)—O—, —NH—C(═O)—NH—, —O—CO—NH—, alkylene, phenylene, aralkylene, -phenylene-C(═O)—O— or -phenylene-S(═O)₂—NH— and
R⁴ represents an oligomer or polymer radical having a molecular weight of at least 250 to 10000 and
R⁴—H exhibits a water solubility of at least 25 g/l at a temperature of 25° C.

5. An ink for an ink jet according to claim 1, wherein the ink contains water and the dye polymer is used in the form of a dispersion of particles with an average diameter of not more than 300 nm.

6. An ink for an ink jet according to claim 5, wherein the polymer particles are structured and are composed of a hydrophobic inner region containing the dye and a hydrophilic shell.

7. A method for preparing a polymer dispersion for use in an ink for ink jet, said ink containing water and a dye linked to a polymer skeleton, wherein the dye is an azomethine dye, an indoaniline dye or an azo dye and the polymer is a copolymer consisting of at least one hydrophobic monomer and at least one hydrophilic, non-ionic monomer, the molecular weight of the hydrophilic, non-ionic monomers being at least 200 and said dye being bound to at least one hydrophobic monomer and wherein said dye polymer is used in the form of a dispersion of particles with an average diameter of not more than 300 nm, wherein the said method comprises the steps of polymerizing at least one azomethine dye, indoaniline dye or azo dye monomer and at least one macromonomer (MA): 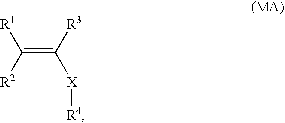
wherein
R¹, R², R³ represent substituents, in particular each independently representing hydrogen, halogen, a C1-C4 alkyl group, —C(═O)—O—R⁵ or —C(═O)—NH—R⁵,
X represents a chemical bond or a linking group,
R⁴ represents an oligomer or polymer radical having a molecular weight ranging from 200 to 20000 and
R⁵ represents hydrogen, alkyl, aryl or aralkyl and
R⁴—H exhibits a water solubility of at least 10 g/l at a temperature of 25° C. in solution in the presence of at least one organic solvent, then adding at least 25% by weight of water to the reaction mixture and then distilling off at least an equivalent amount of the organic solvent until a polymer dispersion composed of particles having a diameter of not more than 300 nm is formed, whereby the organic solvent and the amount of water must be chosen so that the solution is still homogeneous directly after the addition of the water and subsequently a higher amount by weight of organic solvent than water is distilled off.
